(19) United States
(12) Patent Application Publication
(10) Pub. No.: US 2017/0154345 A1
(43) Pub. Date: Jun. 1, 2017

(54) CALCULATING METHOD AND CALCULATING SYSTEM

(71) Applicants: Inventec (Pudong) Technology Corporation, Shanghai (CN); INVENTEC CORPORATION, Taipei City (TW)

(72) Inventors: Chun-Chang WANG, TAIPEI CITY (TW); Fang-Yu LIN, TAIPEI CITY (TW); Shih-Chang KUO, TAIPEI CITY (TW)

(21) Appl. No.: 15/016,200

(22) Filed: Feb. 4, 2016

(30) Foreign Application Priority Data
Nov. 27, 2015 (CN) 201510846723.8

(51) Int. Cl. G06Q 30/02; G06Q 10/06

(52) U.S. Cl. CPC G06Q 30/0201; G06Q 10/067

(57) ABSTRACT

A calculating method of calculating multiple input data is disclosed. The calculating method includes the steps of dividing the input data into training data and testing data, inputting the training data into multiple mathematical models to perform calculation so as to obtain calculating results, comparing the calculating results with the testing data to obtain similarities and repeatedly adjusting parameter combinations of the mathematical models according to the similarities, and selecting one of the mathematical models according to the similarities and the parameter combinations.

### RELATED APPLICATIONS

This application claims priority to Chinese Application Serial Number 201510846723.8, filed Nov. 27, 2015, which is herein incorporated by reference.

### BACKGROUND

Field of Invention

The disclosure relates to a calculating method and a calculating system, and particularly to a calculating method and a calculating system which are suitable for selecting a mathematical model based on parameter adjustment.

Description of Related Art

Current department stores and retail markets provide intelligent product recommendation engines. These product recommendation engines usually make use of background data (such as member data, product data and transaction records) and utilize mathematical models to calculate customer and product related similarity information, and then further provide products recommended to users through the combination of network public opinion data and a short-distance transmission technology. However, there are a variety of mathematical models, and thus results calculated by each mathematical model under different conditions may also be different; that is, each mathematical model has its advantages and disadvantages under different conditions, and the recommended products do not necessarily conform to users' expectations.

### SUMMARY

An aspect of the disclosure provides a calculating method suitable for calculating multiple input data. The calculating method includes the steps of dividing the input data into training data and testing data, inputting the training data into multiple mathematical models to perform calculation so as to obtain calculating results, comparing the calculating results with the testing data to obtain similarities and repeatedly adjusting parameter combinations of these mathematical models according to the similarities, and selecting one of the mathematical models according to the similarities and the parameter combinations.

Another aspect of the disclosure provides a calculating system which includes a database, a division unit, a processing module and a selecting unit. The database is used for storing multiple input data; and the division unit is used for dividing the input data into training data and testing data. The processing module includes a storage module, a calculating unit and a comparison unit. The storage module is used for storing multiple mathematical models and loading the mathematical models into the calculating unit; the calculating unit is used for inputting the training data into multiple mathematical models to perform calculation so as to obtain calculating results; the comparison unit is used for comparing the calculating results with the testing data to obtain similarities and repeatedly adjusting parameter combinations of the mathematical models according to the similarities; and the selecting unit is used for selecting one of the mathematical models according to the similarities and the parameter combinations.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows

FIG. 1 illustrates a block diagram of a calculating system according to an embodiment of the disclosure;

FIG. 2 illustrates a method flow chart of a calculating method suitable for calculating multiple input data according to an embodiment of the disclosure;

FIG. 3 illustrates a schematic view of input data according to an embodiment of the disclosure;

FIG. 4 illustrates a schematic view of input data division according to an embodiment of the disclosure;

FIG. 5 illustrates a schematic view of calculating results according to an embodiment of the disclosure; and

FIG. 6 illustrates a schematic view of testing data according to an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

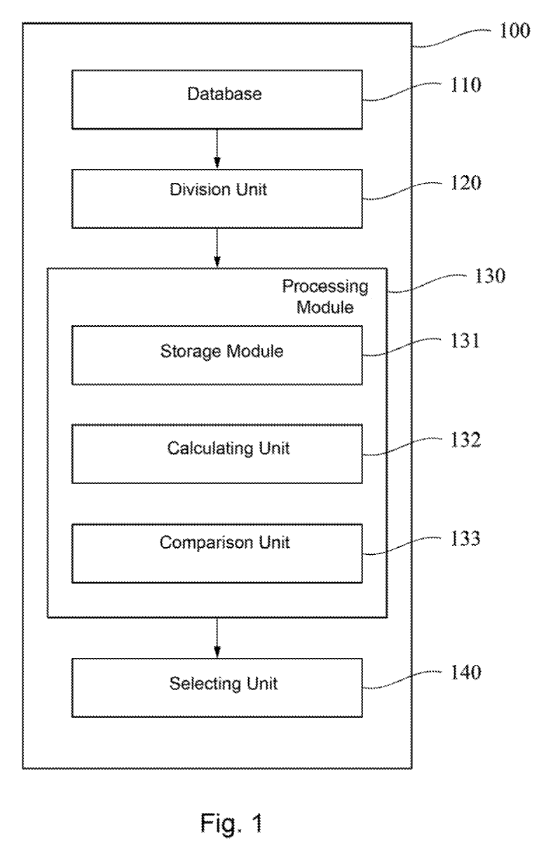

FIG. 1 illustrates a block diagram of a calculating system 100 according to an embodiment of the disclosure. The calculating system 100 includes a database 110, a division unit 120, a processing module 130 and a selecting unit 140.

The database 110 is used for storing multiple input data, and these input data includes already-presented product data, customer data or transaction records, wherein the product data may be data contained in any type of products, such as household appliances, books, clothes and foods. The customer data may include names, addresses, email addresses and telephone numbers and the like of customers. The transaction records may be types, purchase quantity and purchase times of products ever purchased by the customers or evaluation specific to the purchased products and the like.

The division unit 120 is used for dividing the multiple input data into training data and testing data. In one embodiment, the input data may be divided into 80% of training data and 20% of testing data, and the input data may also be divided into 90% of training data and 10% of testing data. The aforementioned division proportions are only used for illustration, and the scope of the disclosure is not limited to the aforesaid embodiments.

The processing module 130 includes a storage module 131, a calculating unit 132 and a comparison unit 133. The storage module 131 is used for storing mathematical models of various different algorithms and loading the mathematical models into the calculating unit 132 (such as a center processing unit (CPU)), wherein these mathematical models are used for calculating similarities between a group of assembly articles. Common mathematical models are, for example, Euclidean distance, Pearson correlation, Tanimoto coefficient, log-likelihood ratio, singular value decomposition and alternating least squares.

The calculating unit 132 is used for inputting the training data into the mathematical models to obtain calculating results. For example, each user gives scores of multiple purchased products, inputs part of the score data into the mathematical models as the training data, and performs similarity calculation by means of the mathematical models, so as to obtain similarities between users and between products, namely calculating results. In some embodiments, the calculating unit 132 may be a device having a calculating capability, such as a center processing unit (CPU).

The comparison unit 133 is used for comparing the calculating results obtained through the calculating unit 132 with the testing data to obtain similarities. Parameters of the mathematical models are repeatedly adjusted according to the similarities. That is to say, the parameters are adjusted according to the similarities, new calculating results may be obtained by performing calculation based on the adjusted new parameters, and then the new calculating results are compared with the testing data to obtain new similarities. The comparison unit 133 continuously adjusts the parameters of the mathematical models in an automatic manner through the aforementioned method until a highest similarity is obtained.

The selecting unit 140 is used for selecting the most suitable one among the multiple mathematical models according to the similarities and the parameter combinations (namely the adjusted parameters); that is, the selecting unit 140 selects the mathematical model corresponding to the parameter combination achieving the highest similarity as above. It will be described in detail in the following paragraphs how to automatically adjust the parameters of the mathematical models and select the most suitable mathematical model according to the similarities.

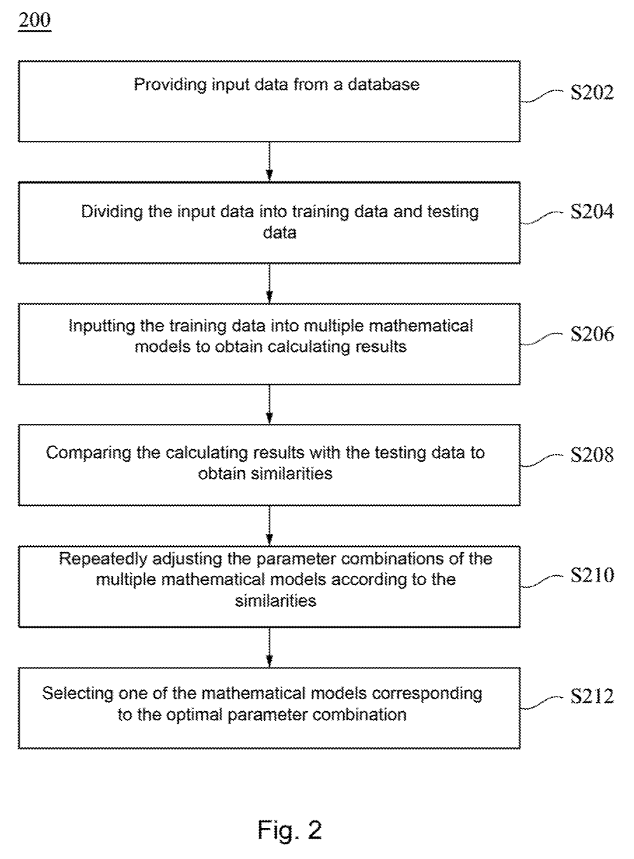

Also referring to FIG. 2, it illustrates a method flow chart of a calculating method 200 suitable for calculating multiple input data IPT according to an embodiment of the disclosure. In step S202, the multiple input data is extracted from the database 110, and as described above the input data may include already presented historical data, such as product data, customer data or transaction records.

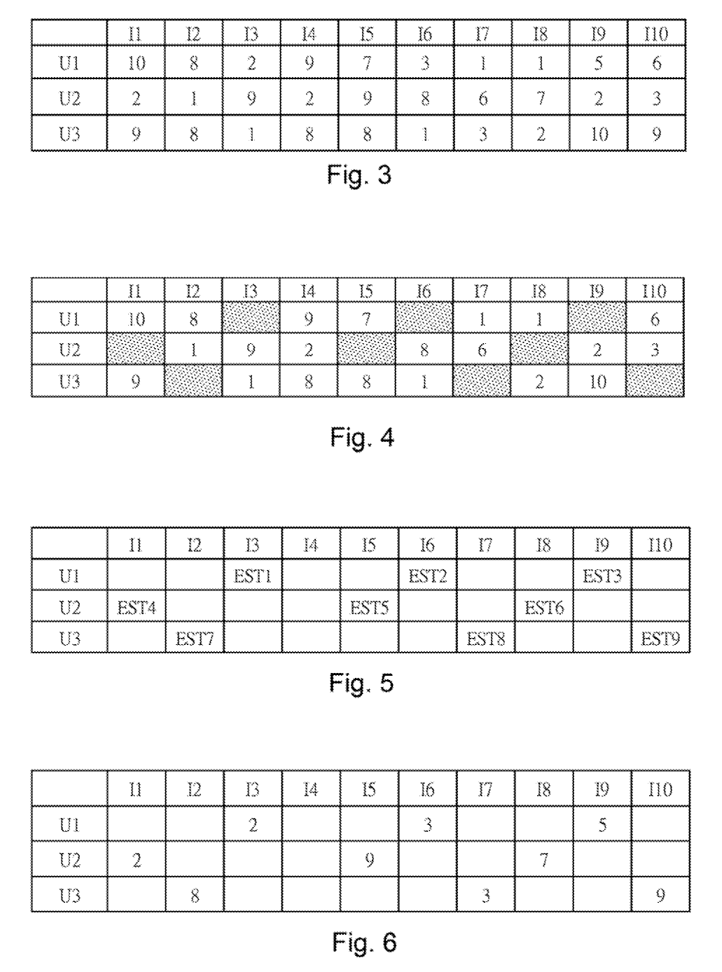

Also referring to FIG. 3, it illustrates a schematic view of input data IPT according to an embodiment of the disclosure. As shown in FIG. 3, users U1-U3 give scores specific to watched movies I1-I10. Numbers represent satisfaction evaluation to the movies I1-I10 as provided by the users U1-U3. When the number is larger, it represents that the satisfaction is higher, and users like the movie better; in contrast, when the number is smaller, it represents users like the movie less. In embodiments, the similarities between users and between products are calculated through user rating data. In other embodiments, the similarities between users and between products may be calculated through other data (such as product data/types, customers' basic data or historical transaction records).

In step S204, the division unit 120 divides the input data IPT into training data and testing data. In some embodiments, the division proportions of the training data and the testing data are 70% and 30%, or 80% and 20%, or 90% and 10%, and the like. Also referring to FIG. 4, it illustrates a schematic view of input data IPT division according to an embodiment of the disclosure. As shown in FIG. 4, users give scores to ten movies I1-I10 and divide score data (namely the aforementioned input data IPT) into training data TRN and testing data TST according to the proportions 70% and 30%, wherein what is contained in black blocks is the testing data TST, and what is not contained in the black blocks is the training data TRN. It should be noted that specific to the d vision proportions and manners of dividing the training data and the testing data, the scope of the disclosure is not limited to the aforementioned embodiments.

After the input data IPT is divided into the training data TRN and the testing data TST, in step S206 the calculating unit 132 inputs the training data TRN into the mathematical models to perform calculation to obtain calculating results. As described in the aforementioned paragraphs, the mathematical models are similarity models commonly used in current related art, such as Euclidean distance, Pearson correlation and Tanimoto coefficient, wherein each mathematical model has adjustable parameters. Based on the parameters and through calculation of the models, the similarities between customers (namely users U1-U3 in embodiments) or the similarities between products (namely movies I1-I10 in embodiments) may be obtained by performing a customer comparison program or a product comparison program.

For example, also referring to FIG. 5, it illustrates a schematic view of calculating results according to an embodiment of the disclosure. As shown in FIG. 5, the training data TRN (namely the data not contained in the black blocks) is input into a mathematical model M1 to calculate the similarities between the users U1-U3, wherein the mathematical model M1 has adjustable parameters P1 and P2. After the mathematical model M1 performs calculation based on the parameters P1 and P2, calculating results EST1-EST9 can be obtained; that is to say, the calculating results EST1-EST3 represent the user U1's preference degree of the movies I3, I6 and I9, as speculated on the basis of the training data through the mathematical model M1.

Similarly, the calculating results EST4-EST6 represent the user U2's preference degree of the movies I1, I5 and I8, as speculated on the basis of the training data through the mathematical model M1. The calculating results EST7-EST9 represent the user U3's preference degree of the movies I2, I7 and I10, as speculated on the basis of the training data through the mathematical model M1.

Also referring to FIG. 6, it illustrates a schematic view of testing data TST according to an embodiment of the disclosure. In step S208, the comparison unit 133 compares the calculating results with the testing data. In embodiments, that is to say, the calculating results EST1-EST9 of FIG. 5 are compared with the testing data TST of FIG. 6 to obtain similarities. In other words, the calculating results EST1-EST3 are compared with the scores U1: [2 for I3, 3 for I6, and 5 for I9] given to movies by the user U1 in FIG. 6; the calculating results EST4-EST6 are compared with the scores U2: [2 for I1, 9 for I5, and 7 for I8] given to movies by the user U2 in FIG. 6; and the calculating results EST7-EST9 are compared with the scores U3: [8 for I2, 3 for I7, and 9 for I10] given to movies by the user U3 in FIG. 6.

Since the similarities (first similarities) between the calculating results EST1-EST9 (namely the first calculating results) calculated on the basis of the parameters P1 and P2 by the mathematical model M1 and the actual testing data TST are low, errors between the calculating results EST1-EST9 (namely the first calculating results) and the testing data are rather large. That is to say, the combination of the initial parameters P1 and P2 of the mathematical model M1 is not the most suitable input data this time.

At the time, in step S210, the comparison unit 133 automatically adjusts adjustable parameters contained in mathematical models according to the first similarities between the first calculating results and the testing data TST; based on the adjusted parameters (namely the first parameter combinations), the comparison unit 133 performs calculation once again and obtains new calculating results (namely the second calculating results), and compares the second calculating results with testing data TST to obtain second similarities. If the second similarities are still very low, the parameters are adjusted once again, and new parameters (namely the second parameter combinations) can be obtained once again.

In this embodiment, the first parameter combinations can be obtained by appropriately adjusting the initial parameters P1 and P2 of the mathematical model M1 according to the similarities (namely the first similarities) between the calculating results EST1-EST9 (namely the first calculating results) and the testing data TST, and based on the first parameter combination, the training data TRN of FIG. 4 is input into the mathematical model M1 again to obtain new calculating results EST1-EST9 (namely the second calculating results). The comparison unit 133 compares the new calculating results EST1-EST9 (namely the second calculating results) with the testing data TST to obtain second similarities.

If the second similarities between the obtained new calculating results EST1-EST9 and the testing data are still very low after the parameters P1 and P2 are adjusted, at the time the comparison unit 133 may adjust the adjusted parameters P1 and P2 once again automatically according to the aforementioned second similarities. It should be noted that in different embodiments, the times of adjusting the parameters are not necessarily the same.

With respect to the repeated parameter adjustment based on the similarities between the calculating results EST1-EST9 and the testing data TST as described above, the implementing manner of the adjustment is an automatic process. That is to say, when the similarities obtained for the first time are very low, the comparison unit 133 may adjust the adjustable parameters in the mathematical model automatically according to the similarities and perform calculation for the second time according to the adjusted new parameters to obtain second calculating results EST1-EST9, and the comparison unit 133 compares the second calculating results EST1-EST9 with the testing data TST to obtain second similarities. It should be understood that the second similarities are higher than the first similarities. In other words, each time the comparison unit 133 automatically adjusts parameters, the obtained new similarities may be higher than the similarities obtained last time. The similarities between the calculating results EST1-EST9 and the testing data TST may be higher and higher along with repeated automatic calculation and adjustment, until the calculating results EST1-EST9 approach the actual testing data TST.

The aforementioned embodiments are described only specific to the mathematical model M1, and actually, in embodiments, other mathematical models M2 and M3 are stored in the storage module 131. According to the aforementioned same method, the same training data TRN is input into the mathematical models M2 and M3 to obtain calculating results, the calculating results are compared with the testing data to obtain similarities, and repeated adjustment is performed on adjustable parameters of the mathematical models M2 and M3. In different embodiments, the times of adjusting the parameters of the mathematical models are different (for example being 3 times, 5 times and 20 times).

The mathematical models M1, M2 and M3 described in the embodiments all possibly have different adjustable parameters; that is, attributes of the parameters of the mathematical models or the parameter adjusting manners are all possibly different (for example, parameter proportions or weights are adjusted upwards). The scope of the disclosure is not limited to the aforementioned embodiments.

After the adjustable parameters contained in each mathematical model are adjusted repeatedly, in step S212 the selecting unit 140 automatically selects a mathematical model according to the similarities and the parameter combinations, wherein the mathematical model has the optimal parameter combination, and the calculating results obtained on the basis of the optimal parameter combination have the highest similarity with and the testing data TST.

For example, in an embodiment, after the adjustable parameters P1 and P2 contained in the mathematical model M1 are adjusted repeatedly, the calculating results EST1-EST9 obtained on the basis of the repeatedly adjusted parameters P1 and P2 are compared with the testing data TST, and it is found that the similarities between the calculating results EST1-EST9 and the testing data TST are very high; that is, errors between the calculating results EST1-EST9 and the testing data are rather small.

On the other hand, when the mathematical models M2 and M3 undergo repeated parameter adjustment in the same manner, the similarities between the calculating results EST1-EST9 of the mathematical models M2 and M3 and testing data are also very high; at the time the similarities obtained through the mathematical models M2 and M3 are compared with the similarities obtained through the mathematical model M1, and as to the mathematical model M1 based on the repeated adjusted parameter combinations, the similarities between the calculating results of the mathematical models M1 and the actual testing data are the highest among the three models. The repeatedly adjusted parameters P1 and P2 are an optimal parameter combination, and at the time, the selecting unit 140 selects the mathematical model M1.

The aforementioned calculating results are calculated from the perspective of users U1-U3 to obtain similarities between the users U1-U3. In another example, the calculating results are calculated from the perspective of products; that is, similarities between the products are calculated. In embodiments, the similarities between the movies I1-I10 are obtained through calculation from the perspective of the movies I1-I10. An execution mode of selecting a mathematical model is the same as the aforesaid embodiments and is not repeated here.

In sum, it can be seen that when input data is different, divided training data and testing data may be different calculating results may also be different, parameter adjustment manners and times may also be different, and the finally selected mathematical model is also different.

For example, if the content of the input data IPT of FIG. 3 is changed, the training data TRN and the testing data TST of the input data IPT are also changed. At the time, the training data TRN is input into the same mathematical models M1, M2 and M3, and the calculating results EST1-EST9 of the mathematical models and the parameter adjustment of each mathematical model may also be different. According to the principle, the finally selected mathematical model corresponding to the optimal parameter is not necessarily the mathematical model M1 (possibly the mathematical model M2 or M3).

In other words, the mathematical models M1, M2 and M3 described in the embodiments of the disclosure have no absolute difference of being good or bad. In the presence of some conditions, the mathematical model M2 is more suitable than the mathematical models M1 and M3; and in the presence of some other conditions, the mathematical model M3 is more suitable than the mathematical models M1 and M2. Therefore, the disclosure emphasizes the consideration of specific input data, and the mathematical model most suitable for calculating the input data content is selected among different mathematical models through the automatic process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A calculating method, suitable for calculating a plurality of input data, the calculating method comprising:
dividing the input data into a plurality of training data and a plurality of testing data;
inputting the training data into a plurality of mathematical models to perform calculation so as to obtain a plurality of calculating results;
comparing the calculating results with the testing data to obtain a plurality of similarities and repeatedly adjusting a plurality of parameter combinations of the mathematical models according to the similarities; and
selecting one of the mathematical models according to the similarities and the parameter combinations.

2. The calculating method of claim 1, wherein the input data comprises a plurality of product data, and the calculation performed by inputting the training data into the mathematical models comprises a product comparison program; the product comparison program classifies the product data according to a plurality of types corresponding to the product data so as to obtain a plurality of product similarities, wherein the calculating results comprise the product similarities.

3. The calculating method of claim 1, wherein the input data comprises a plurality of customer data, and the calculation performed by inputting the training data into the mathematical models comprises a customer comparison program; the customer comparison program classifies the customer data according to a plurality of transaction records corresponding to the customer data so as to obtain a plurality of customer similarities, wherein the calculating results comprise the customer similarities.

4. The calculating method of claim 1, wherein the calculating results comprise a plurality of first calculating results and a plurality of second calculating results; the similarities comprise a plurality of first similarities and a plurality of second similarities; the parameter combinations comprise a plurality of first parameter combinations and a plurality of second parameter combinations; the first calculating results are compared with the testing data to obtain the first similarities, and the first parameter combinations of the mathematical models are generated according to the first similarities; the mathematical models adopt the first parameter combinations to recalculate the training data to obtain the second calculating results, the second calculating results are compared with the testing data to obtain the second similarities, and the second parameter combinations are generated according to the second similarities.

5. The calculating method of claim 4, wherein the second similarities comprise a highest similarity, and the second parameter combinations comprise an optimal parameter combination; the highest similarity corresponds to the optimal parameter combination, and one of the mathematical models corresponding to the optimal parameter combination is selected.

6. A calculating system, comprising:
a database for storing a plurality of input data;
a division unit coupled to the database and used for dividing the input data into a plurality of training data and a plurality of testing data;
a processing module coupled to the division unit, wherein the processing module comprises:
a storage module for storing a plurality of mathematical models;
a calculating unit for inputting the training data into the mathematical models to perform calculation so as to obtain a plurality of calculating results; and
a comparison unit for comparing the calculating results with the testing data to obtain a plurality of similarities and repeatedly adjusting a plurality of parameter combinations of the mathematical models according to the similarities; and
a selecting unit coupled to the processing module and used for selecting one of the mathematical models according to the similarities and the parameter combinations.

7. The calculating system of claim 6, wherein the input data comprises a plurality of product data, wherein the calculation performed by inputting the training data into the mathematical models comprises a product comparison program; the product comparison program classifies the product data according to a plurality of types corresponding to the product data so as to obtain a plurality of product similarities, wherein the calculating results comprise the product similarities.

8. The calculating system of claim 6, wherein the input data comprises a plurality of customer data, wherein the calculation performed by inputting the training data into the mathematical models comprises a customer comparison program; the customer comparison program classifies the customer data according to a plurality of transaction records corresponding to the customer data so as to obtain a plurality of customer similarities, wherein the calculating results comprise the customer similarities.

9. The calculating system of claim 6, wherein the calculating results comprise a plurality of first calculating results and a plurality of second calculating results; the similarities comprise a plurality of first similarities and a plurality of second similarities; the parameter combinations comprise a plurality of first parameter combinations and a plurality of second parameter combinations; the first calculating results are compared with the testing data to obtain the first similarities, and the first parameter combinations of the mathematical models are generated according to the first similarities; the mathematical models adopt the first parameter combinations to recalculate the training data to obtain the second calculating results, the second calculating results are compared with the testing data to obtain the second similarities, and the second parameter combinations are generated according to the second similarities.

10. The calculating system of claim 9, wherein the second similarities comprise a highest similarity, and the second parameter combinations comprise an optimal parameter combination; the highest similarity corresponds to the optimal parameter combination, and one of the mathematical models corresponding to the optimal parameter combination is selected.
